(19) United States
(12) Patent Application Publication
(10) Pub. No.: US 2011/0054725 A1
(43) Pub. Date: Mar. 3, 2011

(54) METHOD FOR TRANSMITTING TARGET VALUES AND/OR TARGET DRIVE TRAIN STATES

(76) Inventors: Johannes Kaltenbach, Friedrichshafen (DE); Notker Amann, Friedrichshafen (DE); Christian Mittelberger, Ravensburg (DE); Stefan Blattner, Vogt (DE)

(21) Appl. No.: 12/743,790

(22) PCT Filed: Oct. 22, 2008
(86) PCT No.: PCT/EP08/64239

§ 371 Date: Nov. 12, 2010

(30) Foreign Application Priority Data
Nov. 20, 2007 (DE) 102007047824.2

(51) Int. Cl. B60W 10/08; B60L 11/14; B60K 6/48

(52) U.S. Cl. 701/22; 180/65.25; 180/65.265; 903/902

(57) ABSTRACT

The invention proposes a method for transferring the desired values and/or the desired drive train states of the strategy for the operative functions in a hybrid vehicle, in particular in a parallel hybrid vehicle, comprising a hybrid control system which is divided into at least two functional layers, with one layer being in the form of a strategic layer and the second layer being in the form of an operative layer, in which method, in a first step, the desired drive train state is transmitted from the strategic layer to the operative layer, with the drive train state which is checked and accepted as a target then being transmitted from the operative layer to the strategic layer, with, in a next step, the drive train state which is currently valid after the change or after the switchover to the target state being transmitted from the operative layer to the strategic layer, and with the desired values for continuous variables of the new state then being calculated in the strategic layer and being transmitted to the operative layer.

The present invention relates to a method for transferring the desired values and/or the desired drive train states of the strategy for the operative functions in a hybrid vehicle, in particular in a parallel hybrid vehicle according to the preamble of patent claim 1.

Hybrid vehicles comprising a hybrid transmission are known from the prior art. In addition to the internal combustion engine, said hybrid vehicles additionally comprise at least one electric motor or an electrical machine. In series hybrid vehicles, a generator is driven by the internal combustion engine, with the generator supplying electrical energy to the electric motor which drives the wheels. Parallel hybrid vehicles are also known, in which the torques of the internal combustion engine and at least one electrical machine which can be connected to the internal combustion engine are added. In this case, the electrical machines can be connected to the belt drive or to the crankshaft of the internal combustion engine. The torques generated by the internal combustion engine and/or the at least one electrical machine are transmitted to the driven axle by means of a downstream transmission.

DE 10 2005 044 268 A1 discloses a method for controlling or regulating the charge state of an energy store or of the energy flow in a hybrid vehicle, this involving the charge state or the energy flow being controlled or regulated in accordance with a cost function for the energy consumption or the emissions. In particular, when carrying out the method, the costs of the electrical energy when drawn from the energy store, the costs of the electrical energy when drawn from the internal combustion engine, and the costs of the mechanical energy when drawn from the energy store and from the internal combustion engine are taken into consideration, with the desired torques for the internal combustion engine and electrical machine being established using a set of energy cost vectors.

Furthermore, the prior art discloses hybrid vehicles which have a hybrid control system which is divided into at least two functional layers, with one layer (strategic layer) comprising the strategic functions or virtually steady-state prespecifications with regard to states and continuous variables, and the second layer (operative layer) comprising the operative functions or dynamic transitions.

This division into at least two functional layers may be performed for various reasons. For example, it may be performed for the purpose of better structuring of the software or for the purpose of realizing so-called “software sharing” between suppliers (operative functions) and OEM, that is to say original equipment manufacturers, (strategic functions).

In this case, the problem may arise that the desired values predefined by the strategic layer do not match the states of the operative layer. The operative functions serve for transition between the different states, with the desired values having to switch over from the strategy to the operative function during a transition between different states. If this happens at the wrong time, the operative function cannot yet convert the desired values predefined by the strategic layer.

This may be the case, for example, when the internal combustion engine is not yet coupled and the strategic layer requests that torque be introduced into the drive train by means of the internal combustion engine. Furthermore, situations may arise in which the predefined desired values are not consistent, this disadvantageously leading to malfunctions in the operative layer.

The present invention is based on the object of specifying a method for transferring the desired values and/or the desired drive train states of the strategy for the operative functions in a hybrid vehicle, in particular in a parallel hybrid vehicle, comprising a hybrid control system which is divided into at least two functional layers, with one layer being in the form of a strategic layer which contains strategic functions and generates prespecifications, and the second layer being in the form of an operative layer which contains the operative functions which convert the prespecifications of the strategic layer, a consistent system being formed by said method being carried out. In particular, the time at which discrete prespecifications or states and also continuous variables, for example torques, are transferred should be determined in such a way that a consistent system is present at any time.

This object is achieved by the features of patent claim 1. Further refinements and advantages according to the invention can be found in the dependent claims.

Accordingly, the method for transferring the desired values and/or the desired drive train states of the strategy for the operative functions in a hybrid vehicle, in particular in a parallel hybrid vehicle, comprising a hybrid control system which is divided into at least two functional layers, with one layer being in the form of a strategic layer and the second layer being in the form of an operative layer, proposes, in a first step, transmitting the desired drive train state from the strategic layer to the operative layer, with the drive train state which is checked and accepted as a target then being transmitted from the operative layer to the strategic layer. In a next step, the drive train state which is currently valid after the change or after the switchover to the target state being transmitted from the operative layer to the strategic layer, with the desired values for continuous variables of the new state then being calculated in the strategic layer and being transmitted to the operative layer.

In the last step, the state to which the desired values apply is preferably also sent, and therefore the problem that the continuous desired values, for example the internal combustion engine torque and/or the electrical machine torque, experience a sudden change is thus lessened.

On account of the design according to the invention, the dependencies between operative control and strategy are reduced since the currently valid drive train state is established by the operative layer, with this information being used by the strategic layer only to calculate and prespecify the setpoint values.

Furthermore, the operative layer determines when the switchover to a new drive train state should take place, with the desired values which are generated by the strategic layer being transferred only to the operative layer. Since the operative layer determines from when a change in state is possible, the fastest possible time can be used for this purpose.

According to the invention, a switchover to the target drive train state can also be performed in the operative layer when the target drive train state has not yet been reached. For example, when a changeover is to be made from the “electrical driving” state to the “hybrid driving” state in accordance with the prespecifications of the strategic layer, the operative layer can signal the “hybrid driving” state to the strategic layer as the currently valid drive train state when an internal combustion engine is started (in this case, the transmission is shifted to neutral and the internal combustion engine is not yet started up).

Advantageously, no transitions in the strategy are controlled by the transmission of the currently valid drive train state from the operative layer to the strategic layer.

Delays in the transmission between the strategic layer and the operative layer advantageously do not lead to problems in terms of the consistency of the system while the method according to the invention is carried out. Such delays may arise, for example, when transmission is carried out between different controllers.

1. A method for transferring the desired values and/or the desired drive train states of the strategy for the operative functions in a hybrid vehicle, comprising a hybrid control system which is divided into at least two functional layers, with one layer being in the form of a strategic layer and the second layer being in the form of an operative layer, characterized in that, in a first step, the desired drive train state is transmitted from the strategic layer to the operative layer, with the drive train state which is checked and accepted as a target then being transmitted from the operative layer to the strategic layer, with, in a next step, the drive train state which is currently valid after the change or after the switchover to the target state being transmitted from the operative layer to the strategic layer, and with the desired values for continuous variables of the new state then being calculated in the strategic layer and being transmitted to the operative layer.

2. The method for transferring the desired values and/or the desired drive train states of the strategy for the operative functions in a hybrid vehicle as claimed in claim 1, characterized in that, in the last step, the state to which the desired values apply is also sent to the operative layer.

3. The method for transferring the desired values and/or the desired drive train states of the strategy for the operative functions in a hybrid vehicle as claimed in claim 1, characterized in that the currently valid drive train state is ascertained by the operative layer, with this information being used by the strategic layer only to calculate and prespecify the desired values.

4. The method for transferring the desired values and/or the desired drive train states of the strategy for the operative functions in a hybrid vehicle as claimed in claim 1, characterized in that the operative layer determines when the switchover to a new drive train state should take place.

5. The method for transferring the desired values and/or the desired drive train states of the strategy for the operative functions in a hybrid vehicle as claimed in claim 4, characterized in that the fastest possible time is used for a change in state.

6. The method for transferring the desired values and/or the desired drive train states of the strategy for the operative functions in a hybrid vehicle as claimed in claim 1, characterized in that a switchover to the target drive train state can also be performed in the operative layer when the target drive train state has not yet been reached.
